(19) United States
(12) Patent Application Publication
(10) Pub. No.: US 2015/0199930 A1
(43) Pub. Date: Jul. 16, 2015

(54) DISPLAY DEVICE

(71) Applicant: NLT Technologies, Ltd., Kanagawa (JP)

(72) Inventor: Takeshi SASAKI, Kanagawa (JP)

(21) Appl. No.: 14/596,358

(22) Filed: Jan. 14, 2015

(30) Foreign Application Priority Data
Jan. 14, 2014 (JP) 2014-004026

(51) Int. Cl. G09G 3/20

(52) U.S. Cl. CPC G09G 3/2007; G09G 2300/08; G09G 2340/0457

(57) ABSTRACT

A display device which can relax a discontinuity feeling in displaying is provided. The display device according to the present invention operated by using a display method in which a lot of pixels having aperture parts are arranged and in which the respective pixels are controlled in a brightness to display images comprises such a pixel structure and a pixel array that concave parts are formed in different four directions and the other directions which are lateral directions on the same plane of the aperture parts of the pixels described above and that the aperture parts of the adjacent pixels are arranged to the concave parts described above.

### FIELD OF THE INVENTION

The present invention relates to a structure of a display device applied to whole flat panel displays, particularly to an aperture form of a display pixel (hereinafter referred to merely as a “pixel”) in a display device. The “pixel” referred above means an aperture region (hereinafter referred to as “an aperture part”) which can actually be controlled in a brightness unless otherwise explained, and a shading region between the pixels is not included therein.

### Background Art

Several kinds of display methods such as LCD, PDP and OLED are available for flat panel displays which are mainly used for display devices displaying pictures and images, and a system (display method) in which a lot of small pixels are arranged and in which the respective pixels are controlled in a brightness to display images is used in all of the above methods, so that the present invention can be applied to them.

To list LCD which is a representative flat panel display as an example thereof, the forms of the pixels described above comprise usually rectangular forms and a form of < shown in Patent Literatures 1 to 3, and forms having plural bent parts obtained by combining the form of <.

When ideal image data (hereinafter referred to as “original images”) which are origins of displayed images are displayed in the display devices described above, a position (hereinafter referred to as “a contour”) of a boundary region between bright and dark patterns of the original images can not be displayed in a finer position than a size of the pixel, and therefore a phenomenon called jaggy in which the contour is displayed in a jagged form is brought about to reduce the quality of the displayed images.

Known as a measure for improving jaggy is, as shown in Patent Literature 4, anti-aliasing treatment in which a brightness of a pixel present in a position corresponding to a contour is controlled to a middle brightness between those of bright and dark patterns at both sides of the contour to put the contour to a state in which it looks blurred, whereby a jagged feeling is inhibited.

### PRIOR ART LITERATURES

### Patent Literatures

Patent Literature 1: Japanese Laid-open Patent Publication No. 2011-150021

Patent Literature 2: Japanese Laid-open Patent Publication No. 2012-234212

Patent Literature 3: Japanese Laid-open Patent Publication No. 2005-257883

Patent Literature 4: Japanese Laid-open Patent Publication No. 1992-188192

### SUMMARY OF THE INVENTION

### Problems to be Solved by the Invention

However, in the conventional anti-aliasing treatment described above, an influence degree of the anti-aliasing treatment is varied depending on a relation of a contour position of an original image with a position of a boundary between pixels.

For example, when a contour position of an original image is present in the vicinity of a center of a pixel, a “blurring feeling” of the contour is strongly displayed, and when the contour position of the original image is present between the pixels, the “blurring feeling” of the contour is weakly displayed. Accordingly, the problem that a discontinuity feeling is brought about in displaying the contour is involved therein.

Problems in the conventional standard pixel forms shown above shall be explained in detail by referring to FIGS. 11 and 12. For example, in a case in which an image pattern of an original image is an image constituted by two values of white and black colors and in which it is not subjected to anti-aliasing treatment, pixels 101 corresponding to contour positions 102 of the original image display usually, as shown in FIG. 11, either of a white color and a black color which constitute the original image pattern.

Since images can not be displayed in a smaller size than that of a pixel unit in display devices such as liquid crystal displays and the like, the contours of actually displayed images are the boundaries of the respective pixels 101. That is, discrete positions determined by the array pitches of the respective pixels 101 are the contours of actually displayed images, and therefore they become jagged contours reflecting the forms of the pixels 101.

A method for improving the above problem includes image processing called the anti-aliasing treatment described above. The anti-aliasing treatment is a method in which the pixel 101 present in the boundary part of the original image is displayed, as shown in FIG. 12, at a brightness residing in the middle of those of the white and black patterns of the original image to thereby blur the positions of the displayed contours and relax the jagged feeling thereof.

In anti-aliasing treatment carried out by a conventional oversampling method shown in Patent Literature 4, a pixel corresponding to a contour position of an original image displays a middle brightness when the contour of the original image passes through the middle of the pixel since an average brightness of the pattern of the original image in the pixel is calculated in an area occupancy ratio corresponding thereto and displayed, and the effect that the contours of the original image are blurred is obtained as shown in a b part of FIG. 12. However, when the contour of the original image passes in the vicinity of the boundary between the pixels, the pixel displays almost a brightness of the original image as shown in an a part of FIG. 12, and therefore the contour is sharpened.

A pixel form and a pixel array in a conventional flat panel display have, as shown in FIGS. 1 and 3, a structure called “square array” in which pixels having an almost rectangular form are arrayed in a cross-cut form, and therefore involved therein is the problem that when the contour of the original image is extended in a direction having a slight angle to a pixel array direction, a blurred part and a sharp part are produced alternately in a relatively long cycle to bring about a discontinuity feeling.

On the other hand, a special array includes a structure called “a delta array” in which the respective pixel lines are arrayed so that the odd pixel line is deviated by 1/2 pixel from the even pixel line. In a case of the delta array, the contour positions of the original images are different depending on the odd line pixel and the even line pixel when the contour of the original image is extended in a direction having a slight angle to a vertical line direction.

Accordingly, when either of the contour positions stays in a sharp state, the other stays in a blurred state, and therefore the discontinuity feeling observed in the case of the square array is relaxed. However, when the contour of the original image is extended in a direction having a slight angle to a horizontal line direction, the states are completely the same as those of the square array to make it impossible to relax the discontinuity feeling.

Thus, an object of the present invention is to provide a display device which can relax a discontinuity feeling in displaying.

### Means for Solving the Problem

To solve the problems, the display device according to the present invention is characterized by a display device operated by using a display method in which a lot of pixels having aperture parts are arranged and in which the respective pixels are controlled in a brightness to display images, comprising a pixel structure and a pixel array in which irregular parts such as concave and convex potions are formed in plural different directions from the centers of the aperture parts of the pixels described above on the same plane and in which the irregular parts of the pixels are arranged in combination with the irregular parts of the adjacent pixels. Further, it is characterized by that lines drawn for connecting the boundaries between the foregoing pixels in the pixel array described above are not straight lines in any directions.

Also, the aperture parts of the respective pixels described above are characterized by having forms based on cross forms such as a cross form or a double cross form.

Further, the pixel structure and the pixel array described above may be a structure and an array in which two or more kinds of the pixels having the aperture parts provided with the foregoing concave parts formed in the four directions described above and the other directions and the pixels having forms obtained by rotating the above pixels by 90 degrees are combined and arranged so that they are adjacent to each other.

On the other hand, the display device according to the present invention is characterized by a display device operated by using a display method in which a lot of pixels having aperture parts are arranged and in which the aperture parts of the respective pixels are controlled in a brightness to display images, comprising such a pixel structure and a pixel array that irregular parts are such as concave and convex potions formed in the aperture parts of the pixels described above, that the pixels are adjacent to aperture parts of pixels adjacent to the irregular parts described above and constituted in an array in which they are arranged in point symmetry or line symmetry and that lines drawn for connecting the boundaries between the pixels described above are not straight lines in any directions.

The pixel structure and the pixel array described above in the above case may be a pixel structure and a pixel array in which a concave part and a convex part of pixels having an arrow feather are disposed oppositely in a pixel array to allow them to be adjacent to and combined with each other and in which they are arranged in a point symmetry.

In a region in which adjacent two pixels are spatially mixed in the respective pixels described above, the closer the pixel adjacent thereto is to an area centroid of the one pixel, the larger the area occupancy ratio of the one pixel to the pixel adjacent thereto is.

### Effects of the Invention

In the present invention, irregular parts are provided in a plane direction of a pixel so that a part of a pixel adjacent thereto is arranged on the irregular parts, whereby the boundaries of the two adjacent pixels are spatially mixed even when the contour position of the original image and the position of the pixel boundary are overlapped, and therefore a “blurring feeling” is obtained.

This relaxes a difference between a blurring feeling when a contour position of an original image is present in the vicinity of a center of the pixel in subjecting the contour to anti-aliasing treatment and a blurring feeling when the contour position of the original image is present in the vicinity of a boundary of the pixel. Also, the effect that the contour is blurred without subjecting the contour to the anti-aliasing treatment is obtained, and therefore jaggy is relaxed.

Further, in a region in which adjacent two pixels are spatially mixed, the closer the pixel adjacent thereto is to an area centroid of the one pixel, the larger the area occupancy ratio of the one pixel to the pixel adjacent thereto is made, whereby gradation is brought about to the blurring feeling of the contour, and the contour having a more natural and continuous feeling is achieved.

### BRIEF DESCRIPTION OF THE DRAWINGS

FIG. 1 is a drawing showing the structure of a cruciform pixel which is one example of the present invention.

FIG. 2a is a drawing showing one example of a conventional square array pixel structure.

FIG. 2b is a drawing showing the pixel structure shown in FIG. 2a, wherein shown is a display state of a case where a contour of an original image agrees with a boundary of the pixel.

FIG. 2c is a drawing showing the pixel structure shown in FIG. 2a, wherein shown is a display state of a case where the contour of the original image is present in the vicinity of a center of the pixel.

FIG. 2d is a drawing showing the pixel structure shown in FIG. 2a, wherein shown is a display state of a case where the contour of the original image is extended in a lateral direction.

FIG. 3a is a drawing showing an array example of a conventional delta array pixel structure.

FIG. 3b is a drawing showing a display state of a contour part in the pixel structure shown in FIG. 3a.

FIG. 3c is a drawing showing a display state of the contour part in the pixel structure shown in FIG. 3a.

FIG. 3d is a drawing showing the pixel structure shown in FIG. 3a, wherein shown is a display state of a case where a contour of an original image is extended in a lateral direction.

FIG. 4a is a drawing showing a display state in a pixel form in Example 1 of the present invention.

FIG. 4b is a drawing showing a display state of a contour part in the pixel structure shown in FIG. 4a.

FIG. 4c is a drawing showing a display state of the contour part in the pixel structure shown in FIG. 4a.

FIG. 4d is a drawing showing the pixel structure shown in FIG. 4a, wherein shown is a display state of a case where a contour of an original image is extended in a lateral direction.

FIG. 5a is a drawing and a graph for explaining a relation of a contour position with a brightness average value in a square array of a rectangular pixel which is a conventional example.

FIG. 5b is a drawing and a graph for explaining a relation of a contour position with a brightness average value in a square array of a rectangular pixel which is a conventional example.

FIG. 6a is a drawing and a graph for explaining a relation of a contour position with a brightness average value in a delta array of a cruciform pixel which is one example of the present invention.

FIG. 6b is a drawing and a graph for explaining a relation of a contour position with a brightness average value in a delta array of a cruciform pixel which is one example of the present invention.

FIG. 7 is a drawing showing a square array structure of a cruciform pixel according to Example 2 of the present invention.

FIG. 8 is a drawing showing a delta array of a cruciform pixel according to Example 3 of the present invention, wherein shown is an array in which a relation of a lateral line with a vertical line in an ordinary delta array is replaced.

FIG. 9a is a drawing showing a pixel structure according to Example 4 of the present invention, wherein shown is a structure in which pixels having irregular parts and pixels symmetrical to the pixels described above are oppositely combined and arranged.

FIG. 9b is a drawing showing a pixel structure according to Example 4 of the present invention, wherein shown is a structure in which pixels having irregular parts and pixels symmetrical to the pixels described above are oppositely combined and arranged.

FIG. 10 is a drawing showing a pixel structure according to Example 5 of the present invention, wherein pixels having double cruciform irregular parts and pixels obtained by rotating the pixels described above by 90 degrees are alternately arranged so that they are adjacent to each other.

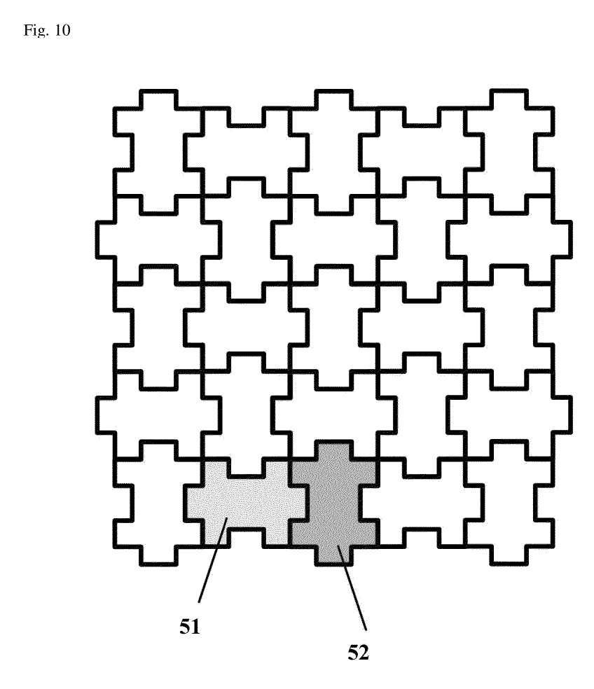

FIG. 11 is a drawing explaining a display state of a case where anti-aliasing treatment is not carried out in a square array of a rectangular pixel which is a conventional example.

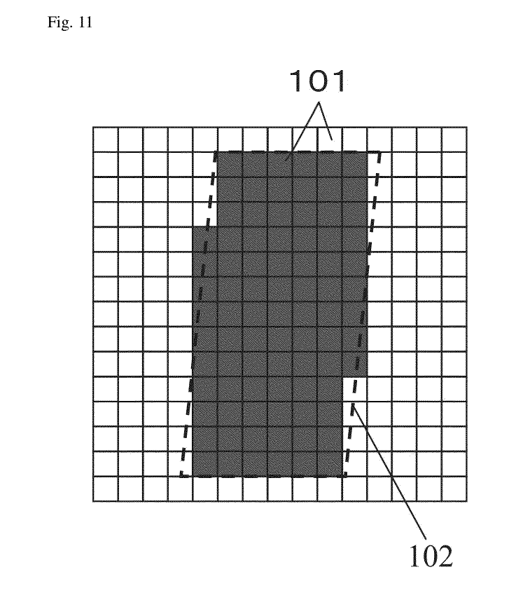

FIG. 12 is a drawing explaining a display state of a case where anti-aliasing treatment using an oversampling system is carried out in a square array of a rectangular pixel which is a conventional example.

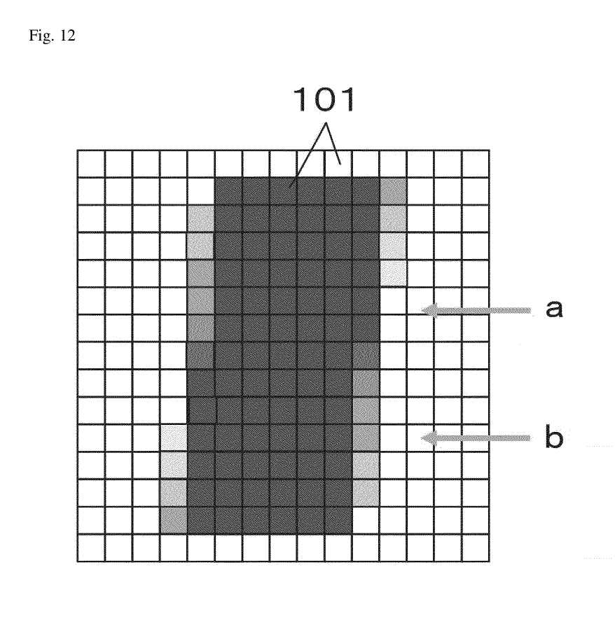

### MODES FOR CARRYING OUT THE INVENTION

Next, the embodiment of the present invention shall be explained in details with reference to the drawings. In the present embodiment, a liquid crystal display device is explained, but the present invention shall not be restricted to the liquid crystal display device and can be applied to the whole display devices such as PDP and organic EL of a system in which a brightness of images is controlled to display the images on the respective pixels. Also, the forms and the arrays of the pixels according to the present invention shall not be restricted to the following examples as long as the object of the present invention is achieved.

### Example 1

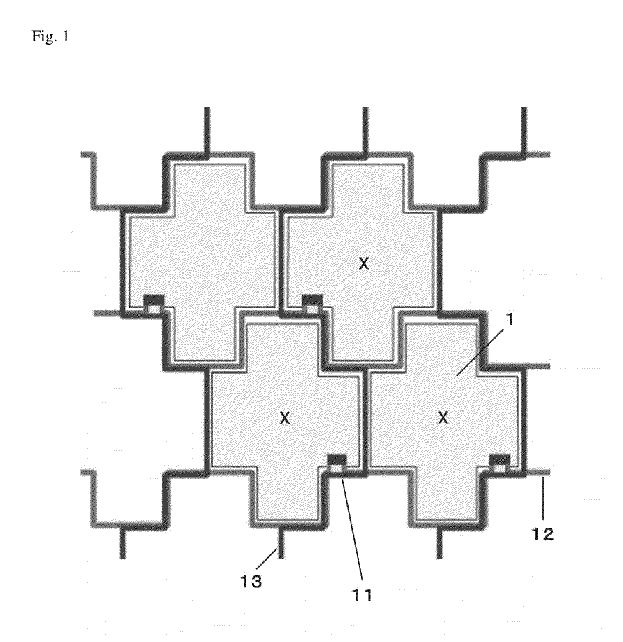

The structure of a liquid crystal display device in Example 1 of the present invention is explained with reference to FIG. 1.

In a case of a liquid crystal display device, a prescribed voltage is applied to the respective pixels 1 to drive the liquid crystal, whereby the respective pixels 1 are controlled in a transmittance. Light emitted from a backlight source transmits through the respective pixels 1 and is emitted from a display surface, and therefore the respective pixels 1 are controlled in a transmittance, whereby the respective pixels can be controlled in a brightness to display the images.

A switching element 11 is disposed on the respective pixels 1 in order to apply a prescribed voltage to the respective pixels 1, and a signal voltage of a data wiring is applied via the switching element 11. Also, the switching element 11 is provided with a gate electrode connected with a gate wiring 12 in order to control the switching element, and the switching element can be controlled in ON/OFF by switching a gate voltage.

In general, the respective pixels 1 are present in a region surrounded by two gate wirings 12 and two data wirings 13 orthogonal to them. An insulating film is present between the gate wiring 12 and the data wiring 13, and therefore both are electrically separated as well in a part where the gate wiring 12 crosses with the data wiring 13.

Both of the gate wiring 12 and the data wiring 13 in the present example have a meandering form, and therefore both of a pixel electrode which is the region surrounded by the gate wirings 12 and the data wirings 13, and an aperture part of the pixel have complicated forms. To be specific, the respective pixels 1 are cruciform, and therefore assumed is a structure in which the irregular parts (concave potions) of the pixel are present in right upper, right lower, left upper and left lower directions corresponding to four directions observing from a centroid of the pixel and in which a part of pixels adjacent to the above irregular parts is combined and arranged.

As described above, providing the irregular parts in 4 or more directions makes it possible to raise the possibility that when the contour position of the original image stays in any positions observing from the centroid X of the pixel, the contour is duplicated on an adjacent pixel.

In the present example, the respective pixels are arranged with the centroids being deviated to lateral line directions by a half of the pixel in the respective pixel lateral lines and upper and lower pixel lateral lines adjacent thereto, and such a pixel array that a triangular shape is formed by connecting the centroids X of the respective pixels is taken (delta array). In other words, the respective pixels are constituted in an array in which they arranged in line symmetry in lateral line directions and which they arranged in point symmetry in oblique upward and downward directions. Moreover, the boundary of these pixels are not straight lines in any directions.

Also, in the present example, the pixel is cruciform, and therefore the pixel is decreased in a width in a part which is increased in a distance from the centroid of the pixel, so that in a region in which the pixel and the pixel adjacent thereto are mixed, taken is the structure in which the pixel is decreased usually in an area occupancy ratio as a distance from the centroid of the pixel is increased.

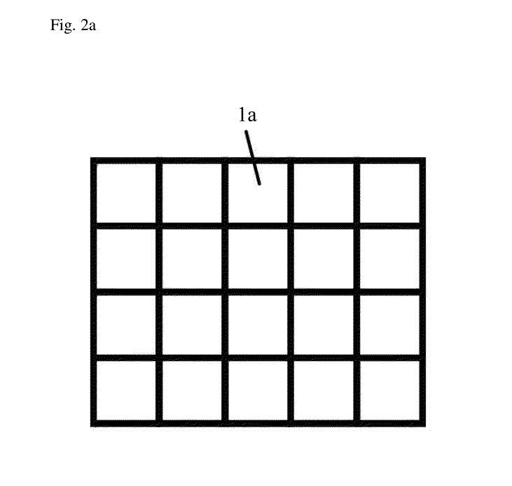

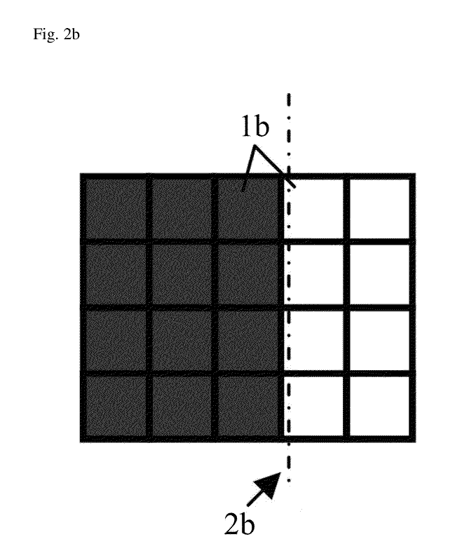

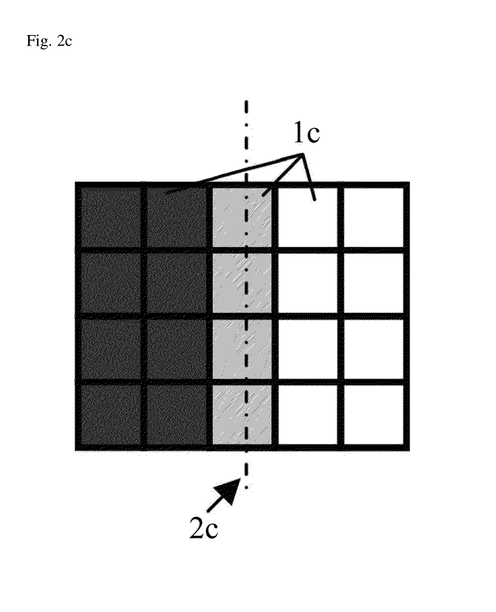

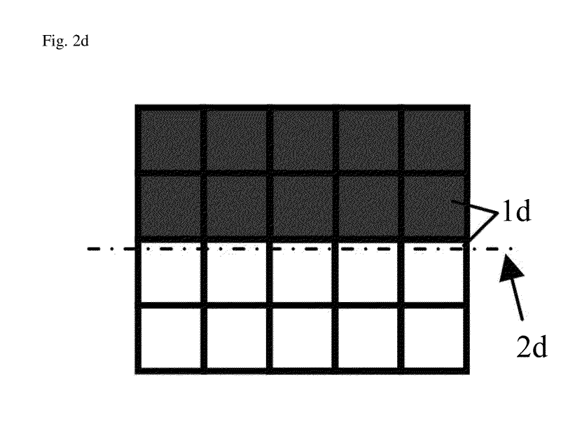

Next, a display method and a display state of an image pattern in the present example shall be explained with reference to FIGS. 2a to 4, wherein a case in which an extending direction of a contour position of a display pattern of an original image is almost parallel to a lateral line direction of a pixel array is taken as an example, and a display state of a case in which an original image pattern is subjected to anti-aliasing treatment and displayed is explained while comparing a conventional pixel structure with a pixel structure in the present example.

For example, when a contour position of an original image agrees with a contour position of a pixel 1b (FIG. 2b) in a conventional rectangular pixel 1a shown in FIG. 2a, a contour 2b of a displayed image is provided with sharp light and dark contrast even when it is subjected to anti-aliasing treatment. In contrast with this, when a contour position 2c of the original image stays in the vicinity of a center of a pixel 1c (FIG. 2c), the pixel concerned is provided with a brightness which resides in the middle of those of pixels on both sides of the contour, and therefore the contour of the pixel is displayed in a blurred manner. Also, as shown in FIG. 2d, the contour position 2d of the original image is displayed in a lateral direction in the pixel 1d form.

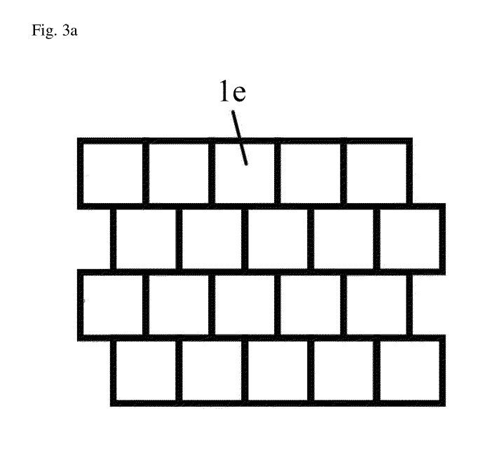

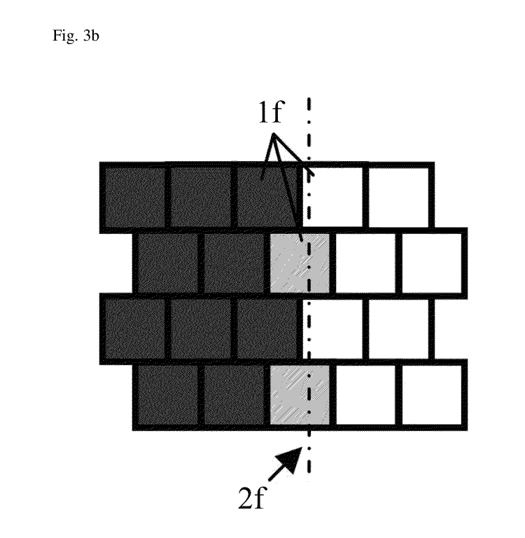

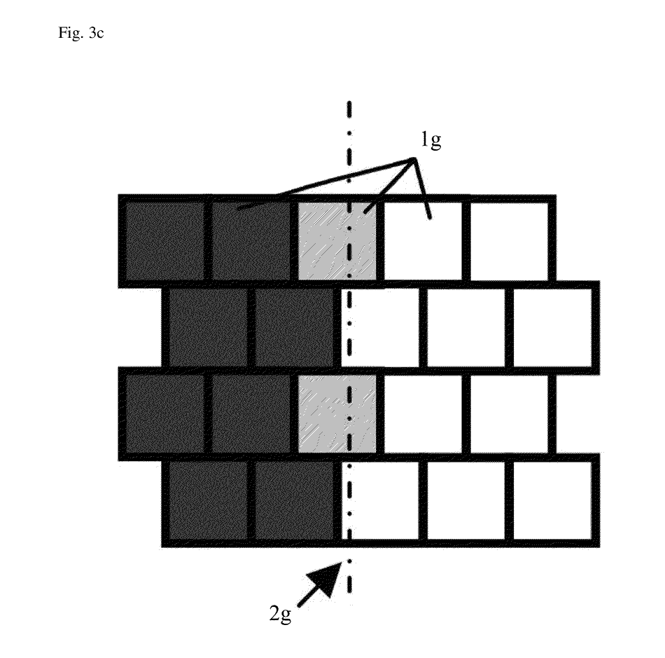

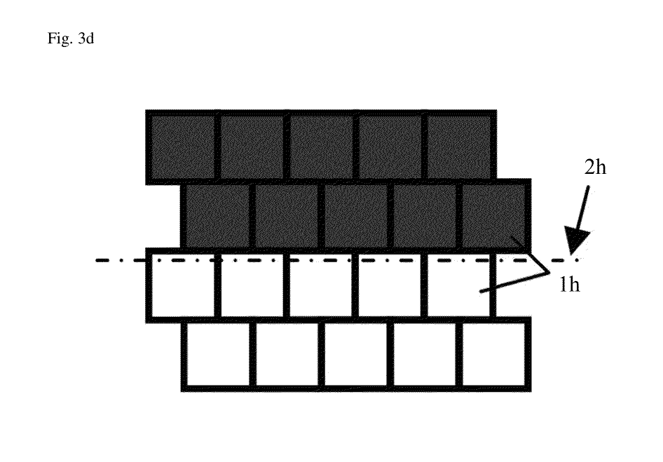

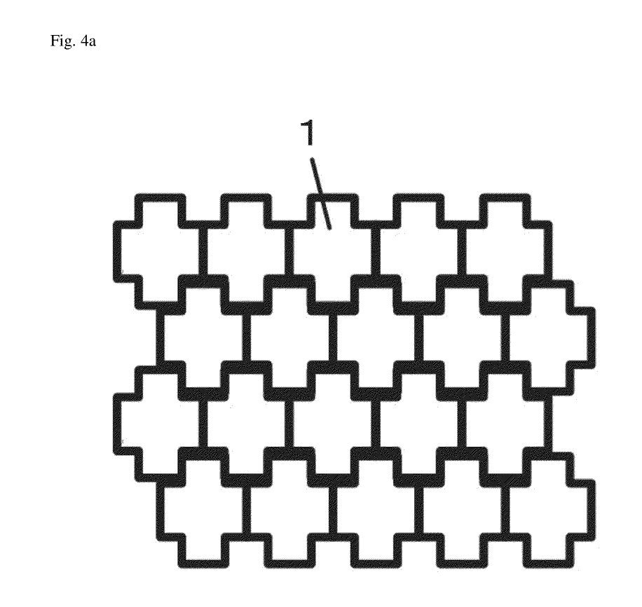

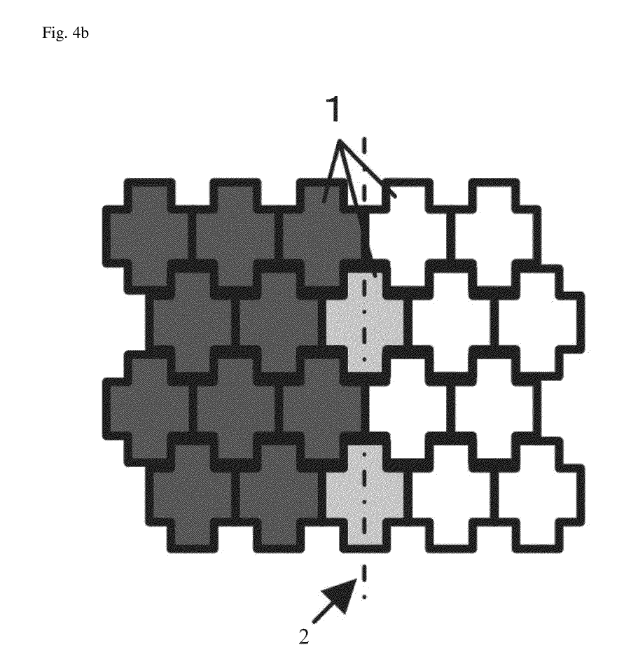

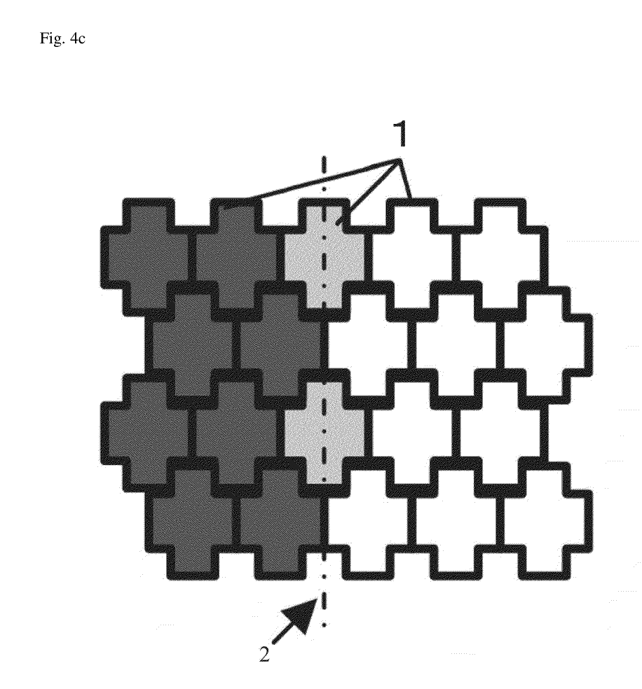

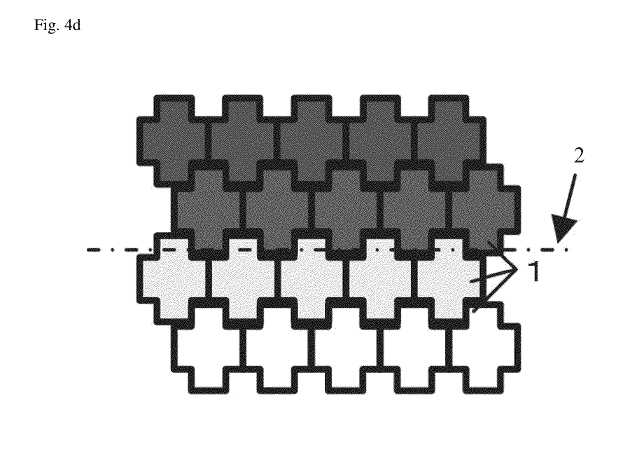

On the other hand, since in a delta array shown in FIG. 3a and the pixel structure of the present example shown in FIG. 4a, the positions of pixels (1, 1e, 1f, 1g, 1h) are deviated by a half pitch in even number vertical lines and odd number vertical lines, the contours of the images in the odd number lateral lines are blurred when the contours of the images in the even number lateral lines are sharply displayed, so that they are put in a complementary state, and anywhere the contour positions (2, 2f, 2g, 2h) of the original images are present, they are put in a suitably blurred state (FIG. 3b, FIG. 3c, FIG. 4b, FIG. 4c, FIG. 4d).

Next, when an extending direction of the contour position of the original image is almost parallel to a lateral line direction of the pixel array, a part in which the boundary position of the pixel and the contour position of the original image are consistent and a part in which they are not consistent are brought about in a case of a delta array (FIG. 3d) as is the case with a vertical line direction of a square array (FIG. 2b, FIG. 2c), and a blurring feeling of the contour displayed is varied depending on the directions. In the explanatory drawings of FIG. 2d and FIG. 3d, the boundary position of the pixel and the contour position of the original image are consistent, and therefore the images are sharply displayed without being blurred.

On the other hand, even in the case described above, the boundaries of the pixel 1 and the contours of the original images are not consistent in the lateral line direction and the vertical line direction in the pixel structure of the present example shown in FIG. 4a, and therefore suitable blurring is inevitably brought about in the contour parts (FIG. 4d).

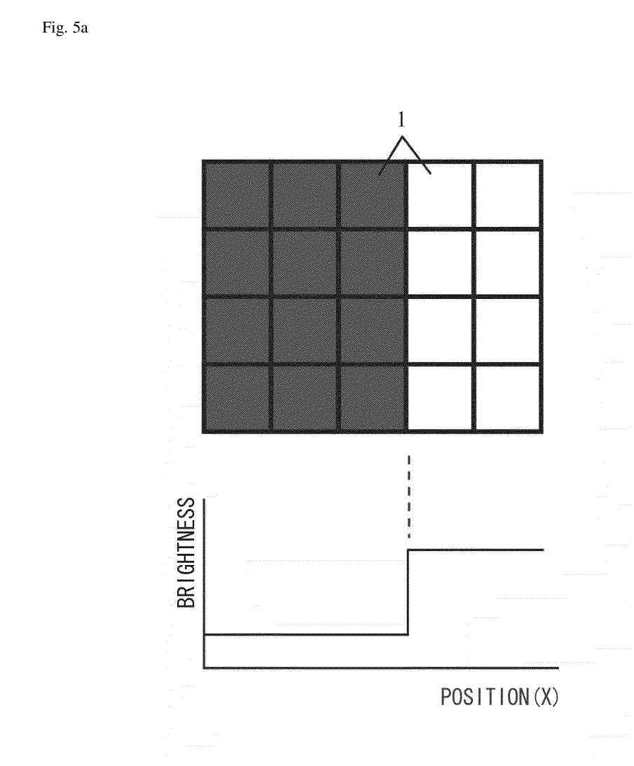

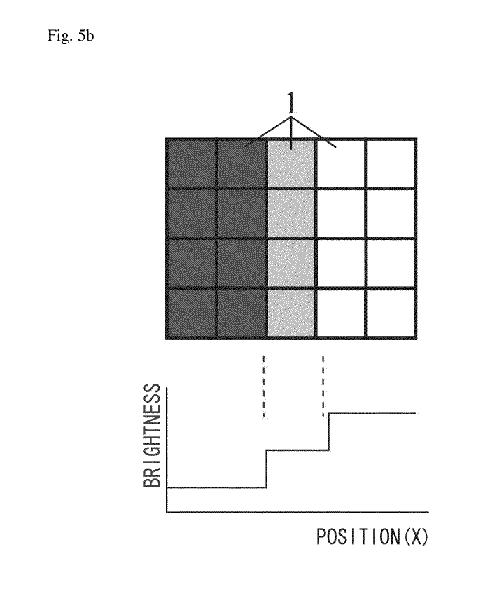

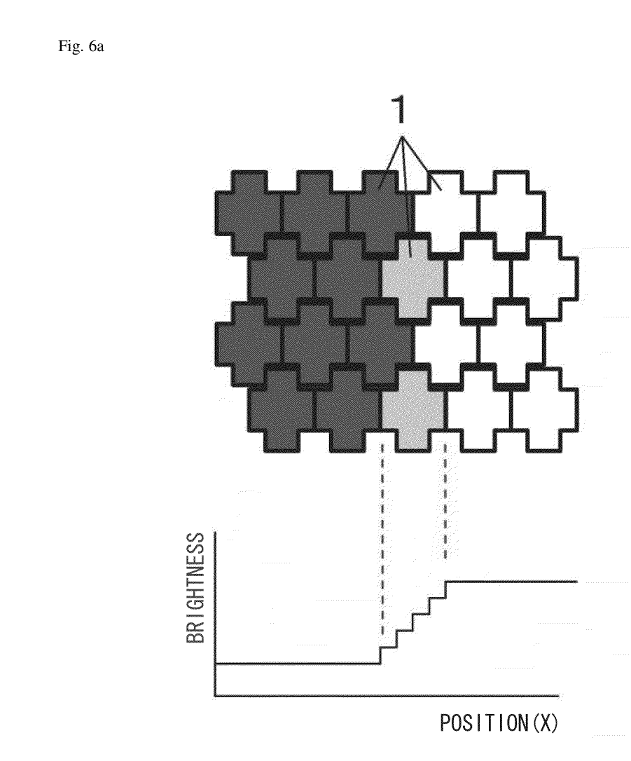

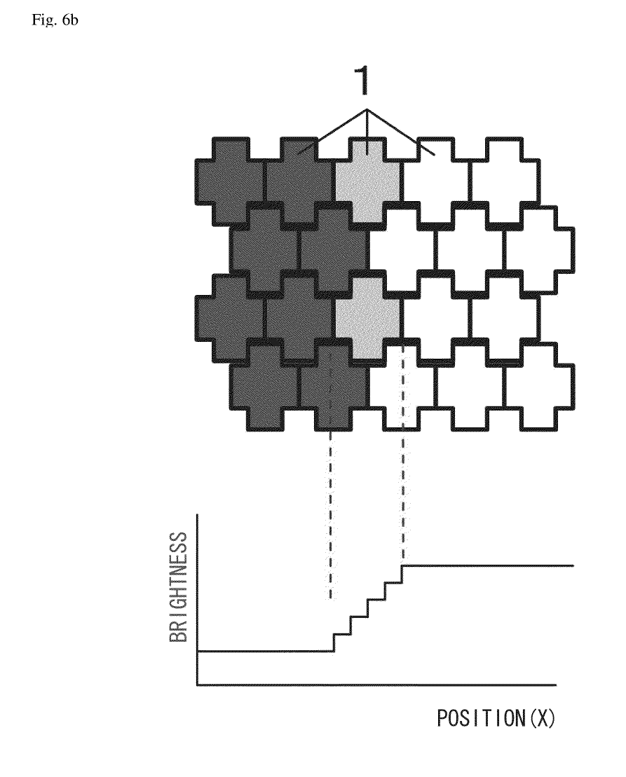

The effects in Example 1 of the present invention are explained with reference to FIGS. 5 and 6. FIGS. 5a and 5b show a display state observed when anti-aliasing treatment is carried out in a conventional pixel structure, and a graph prepared so that it shows a change in the brightness in the vicinity of the contour. A value obtained by averaging brightness values in an extending direction of the contour is allotted to a vertical axis of the graph, and a position in a direction orthogonal to the contour is allotted to a horizontal axis of the graph.

FIG. 5a shows a change in the brightness to the position in the vicinity of the contour when the contour is in the position consistent with the pixel boundary in a conventional pixel structure and pixel array, and the brightness is quickly changed in a boundary of the contour position.

On the other hand, FIG. 5b shows a change in the brightness in the vicinity of the contour when the contour is positioned in the vicinity of a center of the pixel in the conventional pixel structure and pixel array, and the brightness is changed step-wise.

That is, the brightness is changed in a different manner depending on a relation between the contour position and the position of the pixel, and the quality of the displayed image is deteriorated. Also in a part having a middle brightness, only a change in the brightness by a pixel pitch unit can be displayed, and therefore the brightness is changed step-wise, so that the image is displayed in an unnatural blurred manner.

On the other hand, in the structure of a pixel 1 of FIG. 6a in the present example, the images are displayed by almost the same brightness change in FIG. 6a and FIG. 6b in which the contour positions are different, and therefore a homogeneous blurring feeling is obtained anywhere the contours are positioned.

Further, since in the pixel structure of the present example, the pixel is decreased in a displayed area as it is increased in a distance from an area centroid of the pixel, the effect that a part corresponding to the contour part is changed smoothly in a brightness is provided, and a more natural blurring feeling is obtained in the contour part.

Also, the pixel structure in the present example is a structure in which the adjacent pixels are spatially mixed without subjecting them to anti-aliasing treatment, and the contours are blurred, so that the effect that jaggy can be relaxed is obtained.

### Example 2

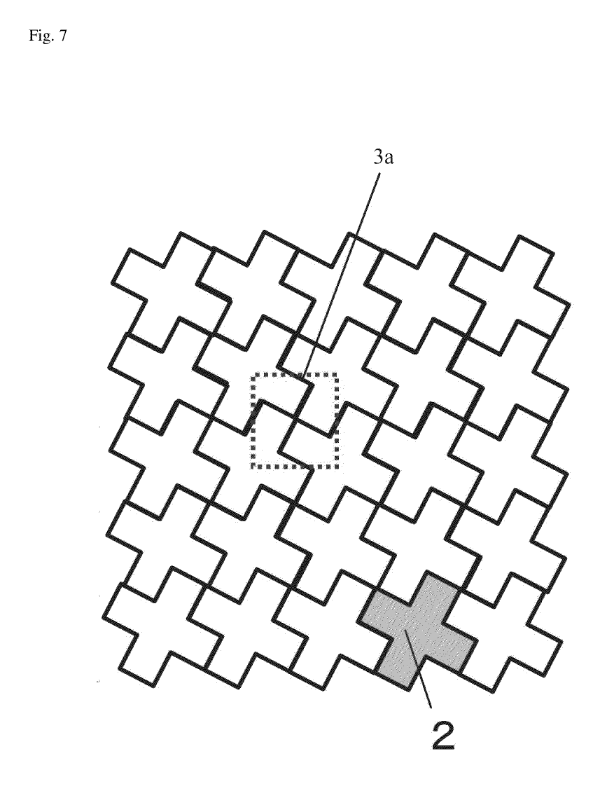

In Example 2 which is another embodiment of the present invention, the form of a pixel 2 is cruciform as is, as shown in FIG. 7, the case with Example 1, and the pixel is obliquely rotated and arranged, whereby the array of the pixel centroid is changed. The pixel array is a square array as shown by an indication number 3a. In other words, the respective pixels are constituted in an array in which they arranged in point symmetry in lateral line directions and in a vertical line direction. Moreover, the boundary of these pixels are not straight lines in any directions.

That is, the centroids of the pixels 2 are arranged in a square array in which the pixel lateral lines and the pixel vertical lines are linearly arranged, whereby provided is the advantage that a conversion processing of the original image to the displayed image is relatively readily carried out as compared with the delta array.

### Example 3

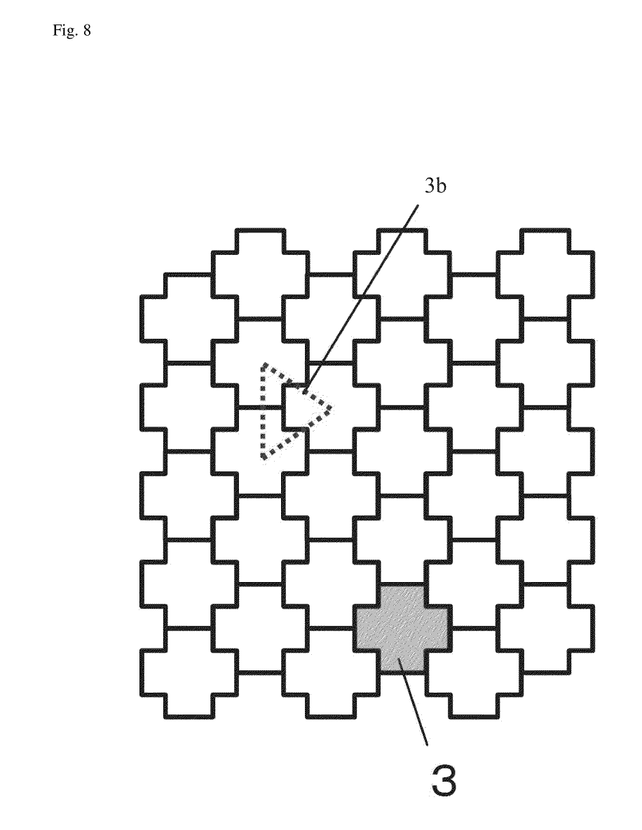

In Example 3 of the present invention, provided is, as shown in FIG. 8, an array in which the lateral lines and the vertical lines in the pixel array are replaced while setting the pixel form to the same one as in Example 1. The pixel array is different by 90 degrees, as shown by an indication number 3b, from an ordinary delta array. In other words, the respective pixels are constituted in an array in which they arranged in line symmetry in a vertical line direction and which they arranged in point symmetry in oblique upward and downward directions. Moreover, the boundary of these pixels are not straight lines in any directions.

That is, in Example 1, the centroids of the respective pixels 1 are linearly arranged in a lateral line direction, and they are arranged in a jagged manner in which the positions are deviated by a 1/2 pixel width in a vertical line direction. On the other hand, in Example 3, the array is set in such a manner that the centroids of the respective pixels 3 are linearly arranged when they are connected in a vertical line direction and that they are arranged in a jagged manner when they are connected in a lateral line direction.

In the pixel structure of the present invention, the same effects can be obtained as well in an array in which the lateral lines and the vertical lines in the delta array are replaced. When it is known in advance in which vertical direction or lateral direction the contour lines of the displayed images are larger, the array of the present example shown in FIG. 8 is more advantageous in a certain case than an ordinary delta array in which an array is deviated every pixel lateral line as is the case with Example 1.

### Example 4

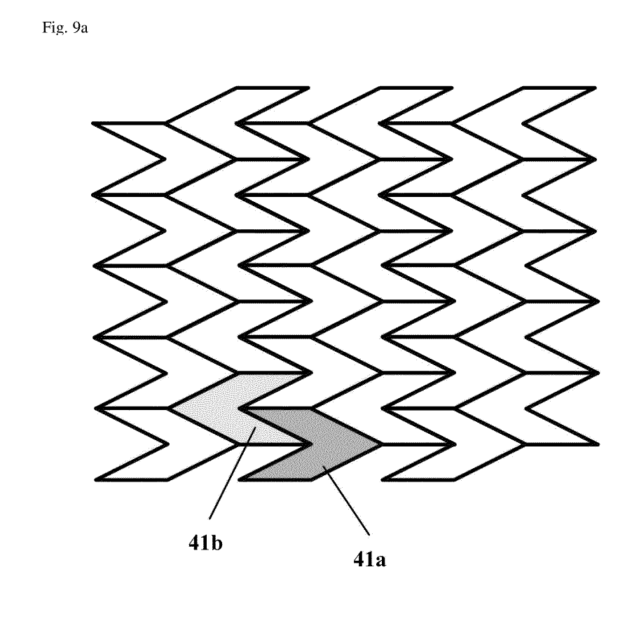

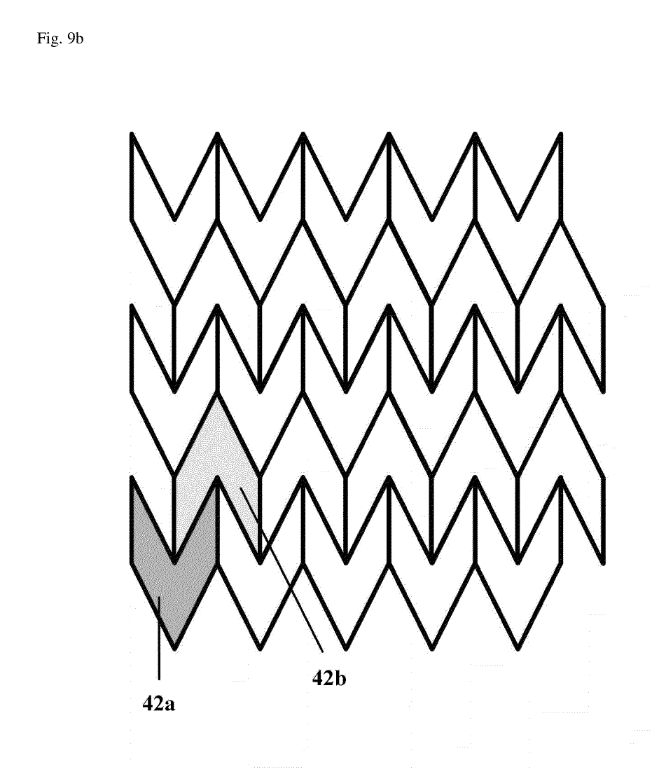

Example 4 of the present invention is explained with reference to FIGS. 9a and 9b. In a display device shown in FIG. 9a which is one of the present examples, adjacent pixels 41a, 41b in which one site of the pixel is arrow feather-wise concave are oppositely disposed and alternately and reversely arranged every one line in a lateral line direction.

Also, in a display device shown in FIG. 9b which is another one of the present examples, pixels 42a and adjacent pixels 42b in which one site of the pixel is concave respectively are reversely arranged every one line in a vertical direction. In both of the above examples, provided is a pixel array in which a side having a concave part in one pixel is arranged to a side having a concave part in the other pixel of a symmetric form with deviation by 1/2 pixel.

To be specific, provided are the structure in which pixel vertical lines constituted by the adjacent pixels 41a having a form of a mark < are alternately arranged and combined and in which the adjacent pixels 41b are arranged with deviation by 1/2 pitch to the centroid in a vertical direction and the structure in which the adjacent pixels 42a are alternately arranged in a lateral line and in which the pixels 42b are arranged with deviation by 1/2 pitch in a lateral direction. In other words, in FIG. 9a, the respective pixels are constituted in an array in which they arranged in line symmetry in a vertical line direction and which they arranged in point symmetry in oblique upward and downward directions. On the contrary, in FIG. 9b, the respective pixels are constituted in an array in which they arranged in line symmetry in a lateral line directions and which they arranged in point symmetry in oblique upward and downward directions.

Due to the above procedure, the pixel boundaries are not linearized in any directions, and therefore the contours do not agree with the pixel boundaries. Accordingly, the contour of the original image is superposed on both of the adjacent pixels, and the contours are not sharply displayed and can provide a natural blurring feeling. One example of Example 4 is shown in FIG. 9a and FIG. 9b, and the forms of the pixels shall not be restricted to the forms of the pixels shown in the examples of the present invention as the means for achieving the objects of the present invention.

### Example 5

Example 5 of the present invention is an example having an array in which a pixel 51 of a double cross form having plural concave parts (6 parts in the present example) and a pixel 52 having a form obtained by rotating the pixel 51 by 90 degrees are combined and alternately arranged so that they are adjacent to each other.

Use of the pixels by changing directions makes it possible to produce complicated boundaries between the pixels by combining them in addition to complicated forms of the pixels themselves, and therefore the blurring feeling can be obtained more intensely. Since the pixels are the same in terms of a form other than an array direction and not different in an area, the data of the original image can be converted to the data of the displayed image by relatively simple processing.

In a region in which adjacent two pixels are spatially mixed in the respective pixels related to the examples described above, the closer the pixel adjacent thereto is to an area centroid of the one pixel, the larger the area occupancy ratio of the one pixel to the pixel adjacent thereto is made, whereby gradation is brought about to the blurring feeling of the contour, and contour treatment having a more natural and continuous feeling is achieved. When applied to color display, it can be achieved by combining with a time sharing system such as a field sequential system and the like.

### DESCRIPTION OF SYMBOLS

1 Pixel (Example 1)
2 Pixel (Example 2)
3 Pixel (Example 3)
41a, 41b Arrow feather-shaped pixels (lateral direction, Example 4)
42b, 42a Arrow feather-shaped pixels (vertical direction, Example 4)
51 Pixel of angle 0° (Example 5)
52 Pixel obtained by rotating the above pixel by an angle of 90° (Example 5)
11 Switching element
12 Gate wiring 12
13 Data wiring
101 Conventional rectangular pixel

What is claimed is:

1. A display device operated by using a display method in which a lot of pixels having aperture parts are arranged and in which the respective pixels are controlled in a brightness to display images, comprising a pixel structure and a pixel array in which irregular parts are formed to plural different directions from the centers of the aperture parts of the pixels described above on the same plane and in which the irregular parts of the pixels are arranged in combination with irregular parts of aperture parts of the adjacent pixels.

2. The display device according to claim 1, comprising such a pixel structure and a pixel array that the pixels described above are constituted in an array in which they are adjacent and arranged in point symmetry or line symmetry and that lines drawn for connecting boundaries between the pixels are not straight lines in any directions.

3. The display device according to claim 1, wherein the aperture parts of the respective pixels described above are characterized by having a cross form, a double cross form or a form based on cross forms.

4. The display device according to claim 1, wherein the pixel structure and the pixel array described above comprise such a structure and an array that the pixels having the aperture parts in which the irregular parts described above are formed in the plural directions and the pixels arranged by tilting these pixels by 90 degrees are combined and arranged so that they are adjacent to each other.

5. The display device according to claim 1, wherein the pixel structure and the pixel array described above comprise a structure and an array in which pixels having a form of a mark < and pixels having a form of a mark > are combined and arranged in point symmetry in a lateral line direction or a vertical line direction.

6. The display device according to claim 1, wherein in a region in which adjacent two pixels are spatially mixed, the closer the pixel adjacent thereto is to an area centroid of the one pixel, the larger the area occupancy ratio of the one pixel to the pixel adjacent thereto is.
